(19) United States
(12) Patent Application Publication
(10) Pub. No.: US 2023/0364654 A1
(43) Pub. Date: Nov. 16, 2023

(54) DUST REMOVAL DEVICE

(71) Applicant: Hugle Development Inc., Tokyo (JP)

(72) Inventors: Yoshihiko KATAOKA, Tokyo (JP); Tomohiro SHIRANE, Tokyo (JP)

(21) Appl. No.: 18/029,536

(22) PCT Filed: Aug. 20, 2021
(86) PCT No.: PCT/JP2021/030512

§ 371 Date: Mar. 30, 2023

(30) Foreign Application Priority Data
Sep. 30, 2020 (JP) 2020-164828

(51) Int. Cl. B08B 5/02; B08B 5/04

(52) U.S. Cl. CPC B08B 5/023; B08B 5/043

(57) ABSTRACT

A dust removal device provided with a discharge outlet 30a (30) and suction inlet 21a, 21b, 22a, 22b facing the surface of an object to be dedusted 100 undergoing relative movement and arranged at a predetermined interval along the direction of relative movement of the object to be dedusted 100 and that discharges gas from the discharge outlet 30 to the surface of the object to be dedusted 10 while drawing in the gas above the surface of the object to be dedusted 100 through the suction inlet 21a, 21b, 22a, 22b. The dust removal device has a gas discharge path 32b with a shape that gradually expands from an opening 33 facing the object to be dedusted 100 to the discharge outlet 30a.

### TECHNICAL FIELD

The present invention relates to a dust removal device for discharging a gas toward a surface of an object to be dedusted undergoing relative movement while drawing in the gas above the surface of the object to be dedusted to thereby remove dust from the surface of the object to be dedusted.

### BACKGROUND ART

Known in the past has been the dust removal device described in PTL 1. This dust removal device is arranged facing a sheet-shaped object (object to be dedusted) that is wound over a guide roll (support part) and is conveyed by rotation of the guide roll at a part abutting against that guide roll. In this dust removal device, a slit-shaped discharge outlet and suction inlet (openings of suction box) which extend in directions perpendicular (width direction of the sheet-shaped object) to the direction of conveyance of the sheet-shaped object (relative movement direction) are formed at a predetermined interval from each other so that the discharge outlet is positioned at the upstream side from the suction inlet in the conveyance direction. Further, in the process of the sheet-shaped object being conveyed, the dust removal device discharges air from the discharge outlet to the sheet-shaped object while drawing in air above the surface of the sheet-shaped object through the suction inlet. Dust sticking to the surface of the sheet-shaped object is dislodged by the air discharged from the discharge outlet and become airborne, and the airborne dust is drawn in from the suction inlet with the air. Due to this, the dust sticking to the surface of the sheet-shaped object is removed (dedusted).

### CITATIONS LIST

### Patent Literature

PTL 1: Japanese Patent Publication No. 5-138136

### SUMMARY

### Technical Problem

In this regard, as shown in FIG. 1, the high speed flow of air discharged from the discharge outlet O (opening) of the above dust removal device (see the bold arrow in FIG. 1) causes the static pressure of the region along the flow to fall and enables a negative pressure BA to be obtained (Bernoulli effect). If a negative pressure BA is produced in the region along the flow of the air being discharged in this way, when the sheet-shaped object 100 being conveyed enters the region facing the discharge outlet O or departs from the discharge outlet O, the negative pressure BA may disturb the conveyance posture of the sheet-shaped object 100. When the conveyance posture of the sheet-shaped object 100 is disrupted in this way, the sheet-shaped object 100 may possibly be sucked into the suction inlet or worsen in posture due to air suction through the suction inlet. This phenomenon is not limited to when the object to be dedusted is a sheet-shaped object but may also similarly occur even with a plate-shaped object due to the negative pressure BA produced by the Bernoulli effect.

For this reason, when used to dedust a sheet-shaped object being conveyed along with rotation of a guide roll, as also described in PTL 1, this kind of dust removal device is arranged facing a portion that is wound with certain tension on the guide roll. Further, when used to dedust the surface of a glass substrate, semiconductor substrate, or other plate-shaped object, the dust removal device is made to move in a state facing the surface of the plate-shaped object fastened by suction on a suction table while dedusting the surface of the plate-shaped object by air discharge and suction. Moreover, when the plate-shaped object is conveyed by a roller conveyer, the plate-shaped object to be dedusted is moved between two oppositely arranged dust removal devices even if only one side is to be dedusted. The influence of air discharged from opposing dust removal devices would thus cancel out, allowing a stable posture to be kept for the plate-shaped object being conveyed.

In this way, conventional dust removal devices had little degree of freedom in how they are placed relative to the object to be dedusted. Further, to ensure the stability of the posture of the object to be dedusted, special mechanisms (for example, a suction table or additional dust removal device) were necessary and the user friendliness was not necessarily that good.

The present invention was made in consideration of these circumstances and provides a dust removal device with good user friendliness.

### Solution to Problem

The dust removal device according to the present invention is a dust removal device provided with a discharge outlet and suction inlet facing the surface of an object to be dedusted undergoing relative movement and arranged at a predetermined interval along the direction of the relative movement of the object to be dedusted and that discharges a gas from the discharge outlet to the surface of the object to be dedusted while drawing in the gas above the surface of the object to be dedusted through the suction inlet, the dust removal device having a gas discharge path with a shape that gradually expands from an opening facing the object to be dedusted to the discharge outlet.

Due to this configuration, when the object to be dedusted undergoes relative movement, the gas passes through the gas discharge path which gradually expands from the opening and is discharged from the discharge outlet to the surface of the object to be dedusted. The discharge pressure of the gas from the opening running along the inner peripheral wall of the gas discharge path so as to be discharged from the peripheral edge portion of the discharge outlet becomes smaller than the discharge pressure of the gas directly discharged from the portion of the discharge outlet facing the opening without running along the inner wall of the gas discharge path. Due to this, the discharge pressure of the gas discharged from the portion of the discharge outlet facing the opening can be kept at a desired pressure while lowering the discharge pressure of the gas discharged from the peripheral edge portion of the discharge outlet. Due to the discharge pressure of the gas discharged from the peripheral edge portion of the discharge outlet decreasing, a negative pressure state caused by the Bernoulli effect becomes difficult to be produced at a region facing the peripheral edge portion of the discharge outlet. Therefore, the object to be dedusted to which the gas discharged from the discharge outlet is blown is more difficult to be influenced by a negative pressure state caused by the Bernoulli effect, and the object to be dedusted to which gas is blown can undergo relative movement stably. The gas discharged from the discharge outlet is blown to the surface of the object to be dedusted which is undergoing relative movement stably, while gas above the surface of the object to be dedusted is drawn in through the suction inlet so that dust on the surface of the object to be dedusted will be removed (dedusted).

The dust removal device according to the present invention can be configured so that a cross-section of the gas discharge path taken vertical to the surface of the object to be dedusted has a shape which gradually expands in an arc shape.

Due to this configuration, the gas from the opening runs along the inner peripheral wall of the gas discharge path with a gradually expanding arc-shaped cross-section so as to be discharged from the discharge outlet and is also directly discharged from the portion of the discharge outlet facing the opening. Due to this, as described earlier, the discharge pressure of the gas discharged from the portion of the discharge outlet facing the opening can be kept at a desired pressure while lowering the discharge pressure of gas discharged from the peripheral edge portion of the discharge outlet. Alternatively, the dust removal device according to the present invention is a dust removal device provided with a discharge outlet and suction inlet facing the surface of an object to be dedusted undergoing relative movement and arranged at a predetermined interval along the direction of the relative movement of the object to be dedusted and that discharges gas from the discharge outlet to the surface of the object to be dedusted while drawing in the gas above the surface of the object to be dedusted through the suction inlet, wherein the discharge outlet includes a plurality of slits which are arranged in a direction traversing the direction of the relative movement of the object to be dedusted with each slit extending in a direction traversing the arrangement direction, a gas discharge path is provided for each of the plurality of slits and extends from an opening facing the object to be dedusted to the slit, and a cross-section of the gas discharge path taken vertical to the slit has a shape which gradually expands from the opening to the slit.

Due to this configuration, when the object to be dedusted is undergoing relative movement, the gas is discharged from each of the plurality of slits through the gas discharge path gradually expanding from the opening. The discharge pressure of gas from the opening running along the inner peripheral wall of the gas discharge path so as to be discharged from the both end parts of each slit in the relative movement direction of the object to be dedusted becomes smaller than the discharge pressure of the gas directly discharged from the portion of each slit facing the opening without running along the inner peripheral wall of the gas discharge path. Due to this, the discharge pressure of the gas discharged from the portion of each slit facing the opening can be kept at a desired pressure while lowering the discharge pressure of gas discharged from the both end parts of each slit. Due to the discharge pressure of the gas discharged from the two end parts of each slit decreasing, a negative pressure state caused by the Bernoulli effect becomes difficult to produce at regions facing the both end parts of each slit. Therefore, the object to be dedusted to which gas discharged from each of the plurality of slits constituting the discharge outlet is blown is more difficult to be influenced by a negative pressure state caused by the Bernoulli effect, and the object to be dedusted to which gas is blown can undergo relative movement stably. Gas discharged from the plurality of slits (discharge outlet) is blown to the surface of the object to be dedusted which is undergoing relative movement stably, while gas above the surface of the object to be dedusted is drawn in through the suction inlet so that dust on the surface of the object to be dedusted is removed (dedusted).

The dust removal device according to the present invention can be configured so that the cross-sectional shape is a shape which gradually expands in an arc shape.

Due to this configuration, the gas runs along the inner peripheral wall of the gas discharge path with an arc-shaped cross-section gradually expanding from the opening so as to be discharged from the both end parts of each slit and is also directly discharged from the portion of each slit facing the opening without running along the inner peripheral wall of the gas discharge path. Due to this, as described above, the discharge pressure of the gas discharged from the portion of each slit facing the opening can be kept at a desired pressure while lowering the discharge pressure of gas discharged from the both end parts of each slit.

The dust removal device according to the present invention can be configured so that each of the plurality of slits is formed inclining obliquely to the conveyance direction of the object to be dedusted.

Due to this configuration, the gas can be blown from the plurality of discretely arranged slits during relative movement of the object to be dedusted not simply in the form of a plurality of lines but over a wider area on the surface of the object to be dedusted.

The dust removal device according to the present invention can be configured so that the plurality of slits are arranged in parallel.

Due to this configuration, the gas discharged from each of the plurality of slits arranged in parallel is blown to the surface of the object to be dedusted undergoing relative movement.

The dust removal device according to the present invention can be configured so that the discharge outlet includes a longitudinal slit extending traversing the plurality of slits.

Due to this configuration, the gas discharged from the longitudinal slit and the gas discharged from each of the plurality of slits can be blown to the surface of the object to be dedusted undergoing relative movement in a state in which the discharge pressure of the gas discharged from the portion of each slit facing the opening can be kept at a desired pressure while lowering the discharge pressure of gas discharged from the both end parts. In this way, the combination of the gas discharged from the longitudinal slit and the gas discharged from each of the plurality of slits can effectively remove dust from the surface of the object to be dedusted undergoing relative movement.

The dust removal device according to the present invention can be configured so that each of the plurality of slits extends in parallel to the direction of the relative movement of the object to be dedusted.

Due to this configuration, the gas discharged from the longitudinal slit and the gas discharged from the plurality of slits can be blown to the surface of the object to be dedusted undergoing relative movement in a plurality of lines extending in the direction of relative movement.

### Advantageous Effects of Invention

According to the dust removal device according to the present invention, a negative pressure state caused by the Bernoulli effect becomes difficult to be produced by gas discharged at high speeds from the discharge outlet, making it possible for the object to be dedusted to which gas discharged from the discharge outlet is blown to stably undergo relative movement. As a result, the framework for stable relative movement of the object to be dedusted receiving gas discharged from the discharge outlet can be simplified and provided with better user friendliness.

### BRIEF DESCRIPTION OF DRAWINGS

FIG. 1 is a view showing the principle behind how a sheet-shaped object being conveyed becomes unstable due to air (gas) discharged from a discharge outlet.

FIG. 2 is a view showing an example of application of a dust removal device according to an embodiment of the present invention.

FIG. 3 is a front view showing a dust removal device according to a first embodiment of the present invention.

FIG. 4 is a plan view showing the dust removal device according to the first embodiment of the present invention.

FIG. 5 is a side view showing the dust removal device according to the first embodiment of the present invention.

FIG. 6 is a bottom view showing the dust removal device according to the first embodiment of the present invention.

FIG. 7 is a cross-sectional view showing a cross-section of the dust removal device taken along the A-A line in FIG. 6.

FIG. 8 is a cross-sectional view showing enlarged a gas discharge path reaching a discharge outlet (slit).

FIG. 9 is a line graph showing the discharge pressure of air discharged from the discharge outlet (slit).

FIG. 10 is a bottom view showing a dust removal device according to a second embodiment of the present invention.

FIG. 11 is a cross-sectional view showing a cross-section of the dust removal device taken along the A-A line in FIG. 10.

FIG. 12 is a cross-sectional view showing a cross-section of the dust removal device taken along the B-B line in FIG. 10.

FIG. 13 is a view of a modification of the discharge outlet.

FIG. 14 is a view of a modification showing another example of application of a dust removal device according to an embodiment of the present invention.

FIG. 15 is a view showing yet another example of application of a dust removal device according to an embodiment of the present invention.

### DESCRIPTION OF EMBODIMENTS

Below, embodiments of the present invention will be explained using the drawings.

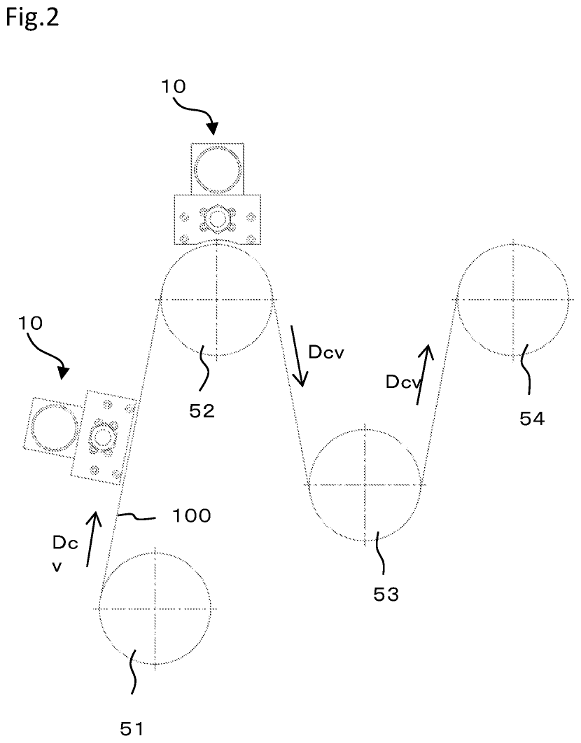

A dust removal device 10 according to the present embodiment is, for example, applied to a system for dedusting a sheet-shaped object 100. In this system, as shown in FIG. 2, a sheet-shaped object 100 as an object to be dedusted fed from a feed roller 51 extends to a take-up roller 54 across tension rollers 52, 53. By synchronous rotation of the take-up roller 54 and feed roller 51, the sheet-shaped object 100 is conveyed from the feed roller 51 toward the take-up roller 54 (conveyance direction Dcv) while certain tension (tension) is applied. The dust removal device 10 may be arranged facing the portion of the sheet-shaped object 100 wound over the tension roller 52. Further, the dust removal device 10 may be arranged facing the portion of the sheet-shaped object 100 where there is no roller or other support part behind it, for example, the portion between the feed roller 51 and tension roller 52.

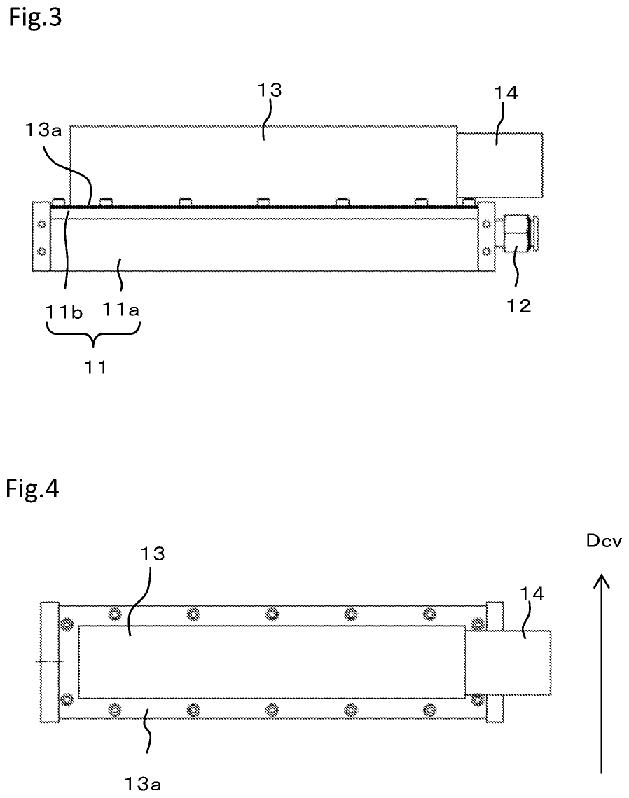

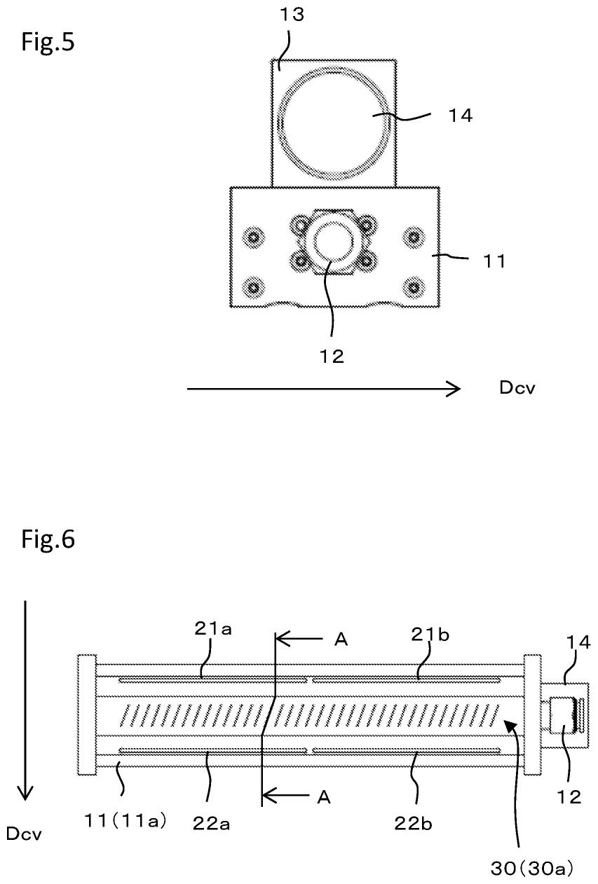

The dust removal device 10 according to the first embodiment of the present invention arranged in the above manner in a system for dedusting a sheet-shaped object 100 (refer to FIG. 2) is constituted in, for example, the manner shown in FIG. 3 to FIG. 6. Note that FIG. 3 is a front view showing the dust removal device, FIG. 4 is a plan view showing the dust removal device, FIG. 5 is a side view showing the dust removal device, and FIG. 6 is a bottom view showing the dust removal device.

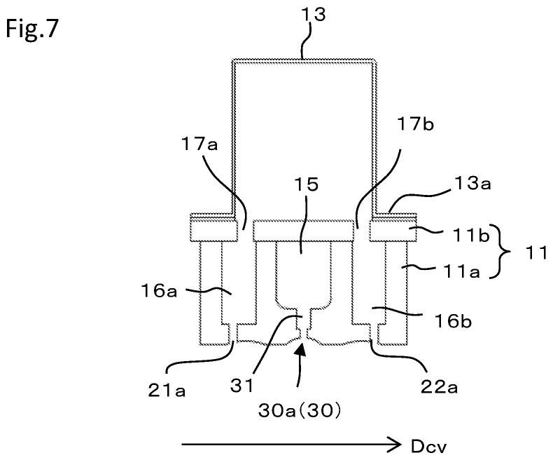

As shown in FIG. 2 together with FIG. 3 to FIG. 5, the dust removal device 10 is provided with an elongated block-shaped dedusting head 11 which extends in a direction perpendicular to the conveyance direction Dcv (relative movement direction) of the sheet-shaped object 100 (direction perpendicular to the plane of the paper in FIG. 2) and an exhaust duct unit 13 which extends along the upper surface of the dedusting head 11. The exhaust duct unit 13 has a bottom which is open and a flange 13a which is formed at the opening edge portion (refer to FIG. 3, FIG. 4, and the later explained FIG. 7, which will be explained later). The flange 13a of the exhaust duct unit 13 is fastened to the upper surface of the dedusting head 11 by a plurality of bolts, whereby the dedusting unit 11 and the exhaust duct unit 13 are integrally joined and the inside of the exhaust duct unit 13 is formed with a space serving as an exhaust path. An exhaust port 14 is provided on a side surface of the exhaust duct unit 13. The exhaust port 14 is connected to a suction mechanism (for example, a vacuum pump: not shown). By operation of the suction mechanism, air (gas) passing through the exhaust path of the exhaust duct unit 13 is discharged to the outside through the exhaust port 14.

A supply port 12 is provided on a side surface of the dedusting head 11. The supply port 12 connects to a supply mechanism for supplying pressurized air (for example, a pressurized pump: not shown). By operation of the supply mechanism, pressurized air is introduced into the dedusting head 11 (later-explained air ejection chamber 20) through the supply port 12. The dedusting head 11 has a structure where a head block 11a and a suction regulating plate 11b are superposed (refer to FIG. 3 and the later explained FIG. 7).

At the surface (bottom) of the dedusting head 11 (head block 11a) facing the sheet-shaped object 100, as shown in FIG. 6, an elongated rectangular front side first suction inlet 21a and front side second suction inlet 21b extending along the front side edge (the upstream edge in the conveyance direction Dcv of the sheet-shaped object 100) are formed aligned. Further, at this surface, an elongated rectangular rear side first suction inlet 22a and rear side second suction inlet 22b extending along the rear side edge (the downstream edge in the conveyance direction Dcv of the sheet-shaped object 100) are formed aligned. Moreover, at the surface (bottom) of the dedusting head 11 (head block 11a) facing the sheet-shaped object 100, a discharge outlet 30 constituted by a plurality of slits 30a is sandwiched by the two front side suction inlets 21a, 21b arranged aligned and the two rear side suction inlets 22a, 22b arranged aligned.

The plurality of slits 30a constituting the discharge outlet 30 are arranged in the longitudinal direction (direction traversing (for example, perpendicular to) the conveyance direction Dcv of the sheet-shaped object 100) of the dedusting head 11 (head block 11a). Further, each of the plurality of slits 30a extends in a direction traversing the direction of their arrangement (direction traversing the dedusting head 11 longitudinal direction, which becomes the width direction of the sheet-shaped object 100) and inclines obliquely to the conveyance direction Dcv of the sheet-shaped object 100.

As shown in FIG. 7 (the cross-section taken along the A-A line in FIG. 6), the head block 11a is formed with, as spaces opening at the surface joined to the suction regulating plate 11b, an air ejection chamber 15, front side air suction chamber 16a, and rear side air suction chamber 16b. The air ejection chamber 15 extends in the longitudinal direction (direction perpendicular to the plane of the paper in FIG. 7) at the center of the head block 11a in the width direction. The front side air suction chamber 16a is formed along the front side edge of the head block 11a (corresponding to the upstream side in the conveyance direction Dcv of the sheet-shaped object 100), and the rear side air suction chamber 16b is formed along the rear side edge of the head block 11a (corresponding to the downstream side in the conveyance direction Dcv of the sheet-shaped object 100).

Further, at the suction regulating plate 11b, respectively passing through the same, front side suction regulating holes 17a and rear side suction regulating holes 17b are formed. The front side suction regulating holes 17a are formed along the front side edge of the suction regulating plate 11b (upstream edge in the conveyance direction Dcv of the sheet-shaped object 100), and the rear side suction regulating holes 17b are formed along the rear side edge of the suction regulating plate 11b (downstream edge in the conveyance direction Dcv of the sheet-shaped object 100). The head block 11a and suction regulating plate 11b are fixed together in a superposed state by a plurality of bolts together with the above-described exhaust duct unit 13 (flange 13a). When the head block 11a and the suction regulating plate 11b are superposed in this way, the air ejection chamber 15 of the head block 11a is closed by the suction regulating plate 11b. Further, when the head block 11a and the suction regulating plate 11b are superposed in this way, the front side air suction chamber 16a and rear side air suction chamber 16b of the head block 11a face the front side suction regulating holes 17a and rear side suction regulating holes 17b of the suction regulating plate 11b.

The front side first suction inlet 21a (and also the front side second suction inlet 21b) formed on the bottom of the head block 11a communicates with the space in the exhaust duct unit 13 (exhaust path) through the front side air suction chamber 16a and front side suction regulating holes 17a formed on the suction regulating plate 11b. The rear side first suction inlet 22a (and also the rear side second suction inlet 22b) formed on the bottom of the head block 11a communicates with the space in the exhaust duct unit 13 (exhaust path) through the rear side air suction chamber 16b and rear side suction regulating holes 17b formed on the suction regulating plate 11b. Due to this, along with air passing through the exhaust path (space) in the exhaust duct unit 13 being discharged to the outside through the exhaust port 14, air is drawn in to the front side first suction inlet 21a (and also the front side second suction inlet 21b) and the rear side first suction inlet 22a (and also the rear side second suction inlet 22b) which communicate with the space in the exhaust duct unit 13.

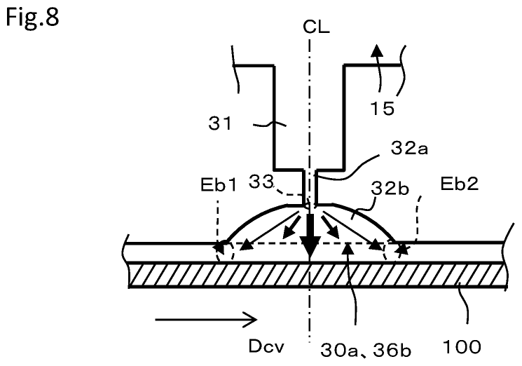

Each of the plurality of slits 30a constituting the discharge outlet 30 formed on the bottom of the head block 11a communicates with a groove 31 formed on the bottom of the air ejection chamber 15 so as to extend in the elongation direction (direction perpendicular to the plane of the paper in FIG. 7) of the head block 11a, and pressurized air introduced from the supply port 12 to the air ejection chamber 15 is discharged from each of the plurality of slits 30a. In more detail, as shown in FIG. 8, a connecting path 32a extending from the groove 31 connects through an opening 33 to a gas discharge path 32b leading to a respective slit 30a. A cross-section of the gas discharge path 32b taken vertical to the slit 30a (the cross-section shown in FIG. 8 taken along the A-A line in FIG. 6) has a shape which gradually expands from the opening 33 to the slit 30a, specifically, a shape that expands gradually in an arc shape.

The operation of the dust removal device with the above-described structure will be explained.

By synchronous rotation of the take-up roller 54 and feed roller 51, the sheet-shaped object 100 is conveyed from the feed roller 51 toward the take-up roller 54 (conveyance direction Dcv) while certain tension (tension) is applied (refer to FIG. 2). In this process, the dust removal device 10 arranged for example between the feed roller 51 and tension roller 52 removes dust from the sheet-shaped object 100 surface in the following way.

In the process of movement of the sheet-shaped object 100, air discharged from the plurality of slits 30a constituting the discharge outlet 30 of the dust removal device 10 is blown to the surface of the sheet-shaped object 100, while air above the sheet-shaped object 100 surface is drawn in through the front side first suction inlet 21a, front side second suction inlet 21b, rear side first suction inlet 22a, and rear side second suction inlet 22b. The airborne dust dislodged by air from the plurality of slits 30a (discharge outlet 30) from the surface of the sheet-shaped object 100 is drawn in together with air through the front side first suction inlet 21a, front side second suction inlet 21b, rear side first suction inlet 22a, and rear side second suction inlet 22b. Due to this, the surface of the sheet-shaped object 100 is dedusted.

The air passing through the gas discharge paths 32b so as to be discharged from each of the plurality of slits 30 will be looked at.

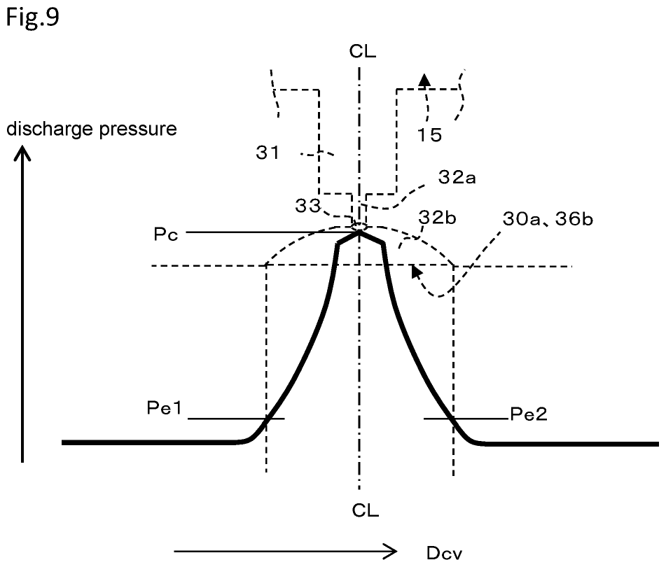

High pressure air passing through the groove 31 and a connecting part 32a from the air ejection chamber 15, as shown in FIG. 8, passes through a gas discharge path 32b gradually expanding from the opening 33 and is discharged from a slit 30a. The discharge pressure of air discharged from each slit 30a is distributed in the manner shown in FIG. 9. That is, the discharge pressure Pe1, Pe2 of air from the opening 33 running along the inner peripheral wall of the gas discharge path 32b and discharged from the upstream end part and downstream end part of the slit 30a becomes smaller than the discharge pressure Pc of air directly discharged from the portion of the slit 30b facing the opening 33 without running along the inner peripheral wall of the gas discharge path 32b.

Due to this, the discharge pressure of air discharged from the portion of each slit 30a facing the opening 30 can be kept at a desired pressure while lowering the discharge pressure Pe1, Pe2 of the air discharged from the both end parts of each slit 30a. Due to the pressure of air discharged from the two end parts of each slit 30a decreasing, a negative pressure state caused by the Bernoulli effect becomes more difficult to produce at regions Eb1, Eb2 (referring to FIG. 8) facing the both end parts of each slit 30a. Therefore, the sheet-shaped object 100 to which air discharged from each of the plurality of slits 30a constituting the discharge outlet 30 is blown becomes more difficult to be influenced by a negative pressure state caused by the Bernoulli effect, and the sheet-shaped object 100 to which air is blown can undergo relative movement (can be conveyed) stably. Further, the air discharged from the plurality of slits 30a is blown in the way described above to the surface of the sheet-shaped object 100 which is undergoing relative movement stably, while the air above the surface of the sheet-shaped object 100 is drawn in through the front side first suction inlet 21a, front side second suction inlet 21b, rear side first suction inlet 22a, and rear side second suction inlet 22b so that dust on the surface of the sheet-shaped object 100 is removed (dedusted).

According to the above-described dust removal device 10, a negative pressure state caused by the Bernoulli effect becomes more difficult to be produced by air discharged at high speeds from the discharge outlet 30 (each of the plurality of slits 30a), and the sheet-shaped object 100 can be stably conveyed while air discharged from the plurality of slits 30a (discharge outlet 30) is being blown. As a result, even if the dust removal device 10 is arranged facing the portion of the sheet-shaped object 100 where is no roller (for example, the tension roller 52 in FIG. 2) or other support part behind it, for example, the portion between the feed roller 51 and tension roller 52 (refer to FIG. 2), the sheet-shaped object 100 can be conveyed stably while dust on the surface is removed. In this way, restrictions on the placement of the dust removal device 10 to ensure that the sheet-shaped object 100 receiving air discharged from the discharge outlet 30 stably undergoes relative movement are reduced (this can lead to a simplification of the framework for stable relative movement of the sheet-shaped object 100 which receives air), providing the dust removal device 10 with better user friendliness.

Further, since each of the plurality of slits 30a constituting the discharge outlet 30 inclines obliquely to the conveyance direction Dcv of the sheet-shaped object 100, air can be blown from the plurality of slits 30a arranged discretely during conveyance of the sheet-shaped object 100 not simply in the form of a plurality of lines but over a wider area on the surface of the sheet-shaped object 100.

A dust removal device according to a second embodiment of the present invention 10 will be explained.

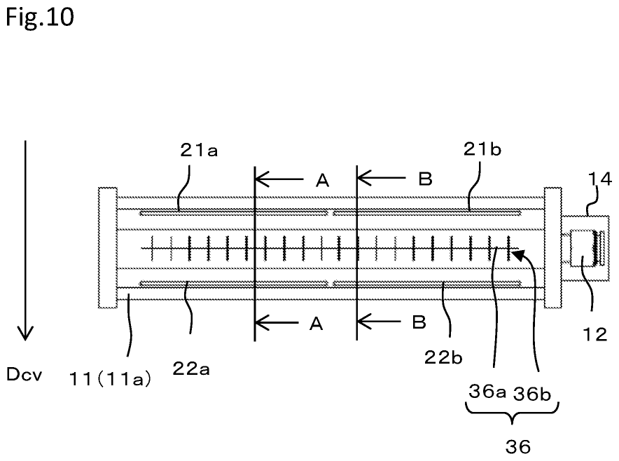

The dust removal device 10 according to the second embodiment is configured such as shown in FIG. 3 to FIG. 5 in the same way as the dust removal device according to the first embodiment. Further, the dust removal device 10 differs from the dust removal device according to the first embodiment in that the discharge outlet is formed as shown in FIG. 10.

In FIG. 10, at the surface (bottom) of the head block 11a (dedusting head 11) facing the sheet-shaped object 100 (object to be dedusted), a discharge outlet 36 is sandwiched by the two front side suction inlets 21a, 21b and the two rear side suction inlets 22a, 22b. The discharge outlet 36 includes a plurality of slits 36b and a longitudinal slit 36a extending in the longitudinal direction (direction traversing the conveyance direction Dcv of the sheet-shaped object 100) at the center of the dedusting head 11a in the width direction (conveyance direction Dcv of the sheet-shaped object 100). The plurality of slits 36b are arranged in the longitudinal direction (direction traversing (for example, orthogonal to) the conveyance direction Dcv of the sheet-shaped object 100) of the head block 11a, and each extends in a direction traversing the longitudinal direction, specifically, a perpendicular direction (conveyance direction Dcv of the sheet-shaped object 100). That is, the relationship between the longitudinal slit 36a and the plurality of slits 36b is that the longitudinal slit 36a traverses, or more specifically, is perpendicular to the plurality of slits 36b.

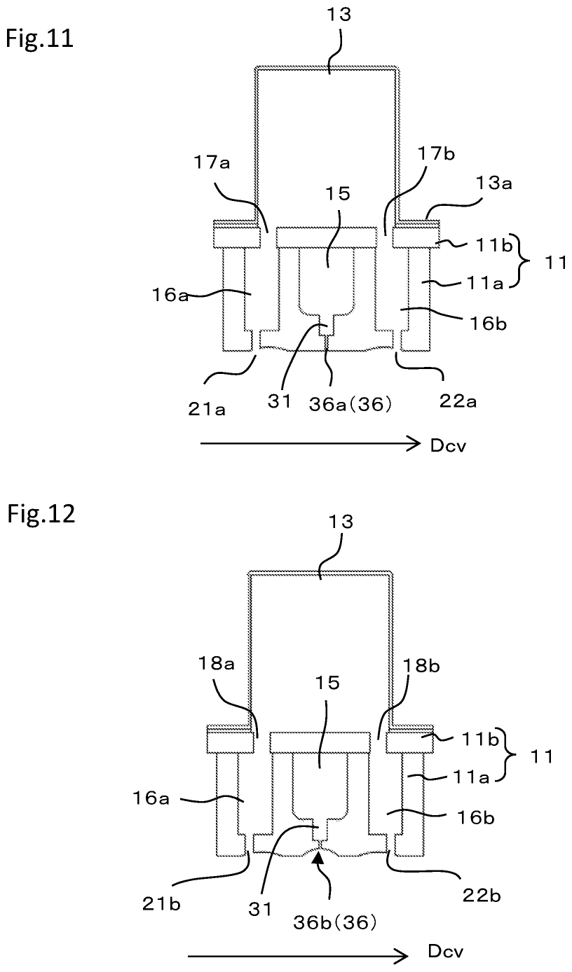

The longitudinal slit 36a, as shown in FIG. 11 (the cross-section taken along the A-A line in FIG. 10), communicates with the air ejection chamber 15 through the groove 31 formed on the bottom of the air ejection chamber 15. Due to this, air introduced from the supply port 12 to the air ejection chamber 15 is discharged from the longitudinal slit 36a. Further, each of the plurality of slits 36b, as shown in FIG. 12, communicates with the air ejection chamber 15 through the groove 31 formed on the bottom of the air ejection chamber 15, and pressurized air introduced from the supply port 12 to the air ejection chamber 15 is discharged from each of the plurality of slits 36b. Looking at each slit 36b in further detail, in the same way as the dust removal device according to the first embodiment, as shown in FIG. 8, the connecting path 32a extending from the groove 31 connects through the opening 33 to the gas discharge path 32b leading to the slit 36b. A cross-section of the gas discharge path 32b perpendicular to the slit 36b (the cross-section shown in FIG. 12 taken along the B-B line in FIG. 10) has a shape which gradually expands from the opening 33 to the slit 36b, specifically, a shape that expands gradually in an arc shape.

In a dust removal device 10 having the above-described dedusting head 11, air is discharged from the longitudinal slit 36a and the plurality of slits 36b, while air is drawn in through the front side first suction inlet 21a, front side second suction inlet 21b, rear side first suction inlet 22a, and rear side second suction inlet 22b. Due to this, in the same way as the dust removal device according to the first embodiment, dust on the surface of a sheet-shaped object 100 being conveyed facing the dust removal device 10 (dedusting head 11) is removed (dedusted).

In further detail, in the same way as the dust removal device according to the above-described first embodiment (refer to FIG. 8 and FIG. 9), the pressure of air discharged from the portion of each of the plurality of slits 36b facing the opening 33 is kept at a desired pressure while the discharge pressure of air gradually decreases toward the both end parts of each slit 36b (upstream end part, downstream end part) (refer to FIG. 9). Due to the discharge pressure of air discharged from the both end parts of each slit 36b decreasing in this way, a negative pressure state caused by the Bernoulli effect becomes difficult to be produced at regions Eb1, Eb2 facing the two end parts of each slit 36b (refer to FIG. 8). On the other hand, air of the desired pressure is discharged straight from the longitudinal slit 36a.

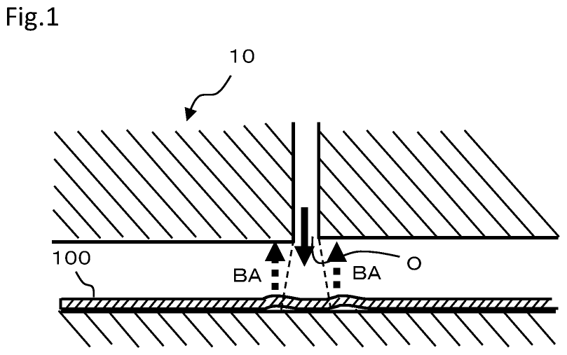

The sheet-shaped object 100, without being influenced by a negative pressure state caused by the Bernoulli effect, enters where the air is discharged from the plurality of slits 36b (facing region Eb1; refer to FIG. 8) and moves while receiving air gradually rising in pressure. Due to this, the sheet-shaped object 100 can move without the posture being disturbed. Further, the sheet-shaped object 100 moves while receiving air discharged from the longitudinal slit 36a at the desired pressure and air discharged from the portion of each of the plurality of slits 36b facing the opening 33 at the desired pressure. At a portion of the longitudinal slit 36a between two slits 36b at this time, the high speed flow of discharged air causes the static pressure of the region along the flow to decrease and enables a negative pressure to be obtained (Bernoulli effect; refer to FIG. 1). Even if a negative pressure state is produced in this region, since the moving sheet-shaped object 100 will be pressed down by air gradually rising in pressure discharged from the adjacent two slits 36b, the posture of the sheet-shaped object 100 can be kept from being disrupted.

Further, the sheet-shaped object 100 passing through air discharged from the longitudinal slit 36a receives air discharged at a gradually decreasing pressure from the plurality of slits 36b while departing from the regions facing the downstream end parts (facing region Eb2; refer to FIG. 8). Since a negative pressure state caused by the Bernoulli effect becomes difficult to be produced in each region facing the downstream end part of a respective slit 36b as was described above, the sheet-shaped object 100 can pass through the regions facing the upstream end parts of the plurality of slits 36b (facing region Eb2) without the posture being disturbed.

According to the dust removal device according to the above-described second embodiment of the present invention 10, air discharged from the longitudinal slit 36a and air discharged from each of the plurality of slits 36b can be blown to the surface of the sheet-shaped object 100 being conveyed in a state in which the discharge pressure of air discharged from the portion of each slit 36b facing the opening 33 is kept at a desired pressure while the discharge pressure of air discharged from the both end parts (upstream end part, downstream end part) is reduced. In this way, the combination of the air discharged from the longitudinal slit 36a and the air discharged from each of the plurality of slits 36b can effectively remove dust from the surface of the sheet-shaped object 100 being conveyed without disrupting the posture.

Since dust can be removed from the surface of the sheet-shaped object 100 while the sheet-shaped object 100 is being conveyed stably in this way, restrictions on the placement of the dust removal device 10 to ensure that the sheet-shaped object 100 receiving air discharged from the discharge outlet 36 (longitudinal slit 36a, plurality of slits 36b) stably moves are reduced. For this reason, the dust removal device 10 according to the second embodiment like the dust removal device according to the first embodiment is provided with better user friendliness.

Note that although the plurality of slits 36b each extend in an perpendicular direction (conveyance direction Dcv of the sheet-shaped object 100) to the longitudinal direction of the head block 11a (direct traversing (orthogonal to) the conveyance direction Dcv of the sheet-shaped object 100) in the above-described dust removal device 10 (second embodiment), the slits are not limited to this and may be inclined obliquely to the conveyance direction Dcv of the sheet-shaped object 100 in the same way as the first embodiment.

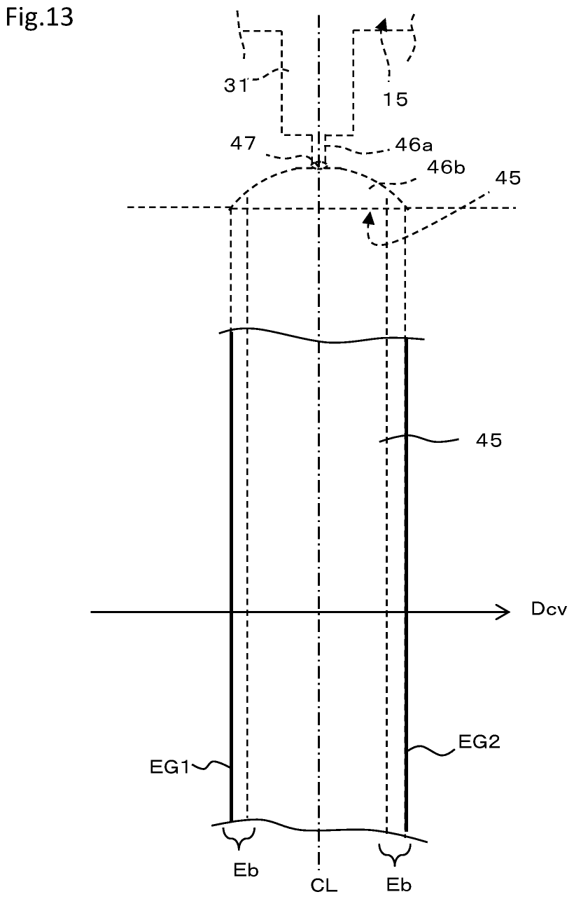

Further, although each of the above-described dust removal devices 10 has a discharge outlet which includes a plurality of slits, they are not limited to this. For example, as shown in FIG. 13, the discharge outlet can be formed as an elongated hole 45 extending in a direction traversing (for example, perpendicular to) the conveyance direction Dcv of the sheet-shaped object 100, that is, the width direction of the dedusting head 11. In this case, in the dedusting head 11 (head block 11a), a connecting path 46a further extending from the groove 31 continuing from the air ejection chamber 15 connects through the opening 47 to the elongated hole 45 leading to the gas discharge path 46b. A cross-section taken vertical to the elongated hole 45 of the gas discharge path 46b (shown by the broken line in FIG. 13), like that described earlier (refer to FIG. 8), has a shape which gradually expands from the opening 47 to the elongated hole 45, specifically, a shape which gradually expands in an arc shape.

In a dust removal device 10 in which the discharge outlet is constituted by an elongated hole 45 in this way, in the same way as that described earlier, the discharge pressure of air from the opening 47 running along the inner peripheral wall of the gas discharge path 46b and discharged from the upstream end part EG1 of the elongated hole 45 in the conveyance direction Dcv of the sheet-shaped object 100 being conveyed becomes smaller than the discharge pressure of air directly discharged from the portion of the elongated hole 45a facing the opening 43 without running along the inner peripheral wall of the gas discharge path 46b. Due to this, the pressure of air discharged from the portion of the elongated hole 45 facing the opening 47 can be kept at a desired pressure while decreasing the discharge pressure of air discharged from the upstream end part EG1 and downstream end part EG2 of the elongated hole 45.

Due to the discharge pressure of air discharged from the upstream end part EG1 and the downstream end part EG1 of the elongated hole 45 decreasing in this way, a negative pressure state caused by the Bernoulli effect is more difficult to be produced at a region Eb facing the upstream end part EG1 and downstream end part EG2 of the elongated hole 45 in the same way as that described earlier. Therefore, the sheet-shaped object 100 to which air discharged from the elongated hole 45 is blown becomes difficult to be influenced by a negative pressure state caused by the Bernoulli effect, and the sheet-shaped object 100 to which air is blown can stably move. Further, air discharged from the plurality of elongated holes 45 (discharge outlet) is blown to the surface of the sheet-shaped object 100 being conveyed stably, while air above the surface of the sheet-shaped object 100 is drawn in through the front side first suction inlet 21a, front side second suction inlet 21b, rear side first suction inlet 22a, and rear side second suction inlet 22b so that dust on the surface of the sheet-shaped object 100 is removed (dedusted).

In this case, since dust can be removed from the surface of the sheet-shaped object 100 while the sheet-shaped object 100 is being conveyed stably, restrictions on the placement of the dust removal device 10 to ensure that the sheet-shaped object 100 receiving air discharged from the elongated hole 45 (discharge outlet) moves stably are reduced. For this reason, the dust removal device is provided with better user friendliness.

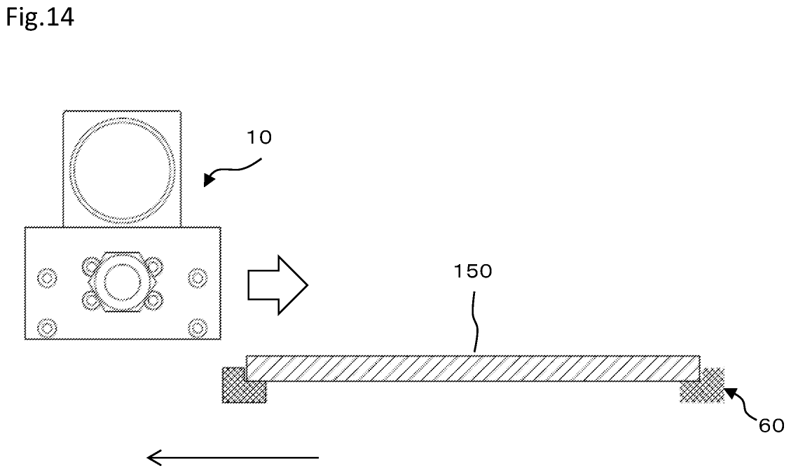

Each of the above-described dust removal devices 10 can be applied to a system for dedusting a glass substrate, semiconductor substrate, or other plate-shaped object. For example, a plate-shaped object 150 to be dedusted is, as shown in FIG. 14, set on a simple tabletop, rather than held by vacuum by an expensive suction table, and a dust removal device 10 is moved facing the surface of the plate-shaped object 150 in this state. Since a negative pressure state caused by the Bernoulli effect when air is discharged from the discharge outlet 30 (36) of the dust removal device 10 (dedusting head) becomes difficult to be produced in this case, the posture of the plate-shaped object 150 set on the simple tabletop 60 can be stably kept (kept from being lifted up) while removing dust on the surface of the plate-shaped object 150.

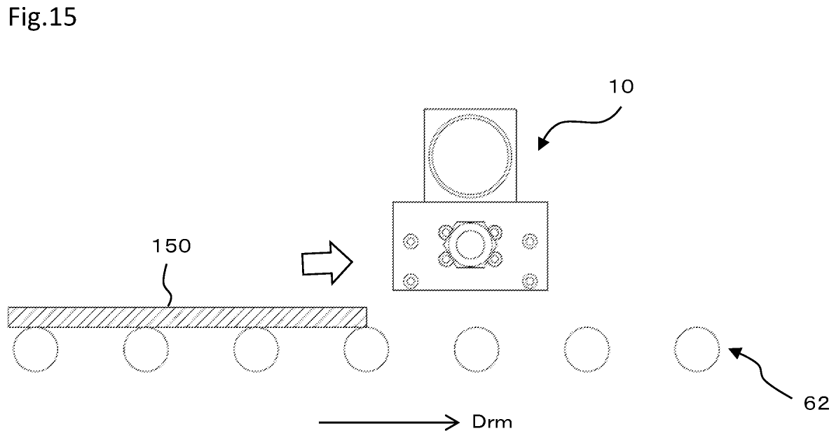

Further, for example, as shown in FIG. 15, instead of dust removal devices 10 being arranged facing the two sides of the plate-shaped object 150 to be dedusted being conveyed on a roller conveyor 62, a dust removal device 10 is arranged facing one side of the plate-shaped object 150. Since a negative pressure state caused by the Bernoulli effect when air is discharged from the discharge outlet 30 (36) of the dust removal device 10 (dedusting head) becomes difficult to be produced in this case, the posture of the plate-shaped object 150 being conveyed by the roller conveyor 62 can be stably kept (the object kept from being lifted up) while removing dust on the surface (one side) of the plate-shaped object 150.

In this way, even when a plate-shaped object 150 is made the object to be dedusted, the above-described dust removal device 10 can simplify the framework by which the object to be dedusted (plate-shaped object 150) receiving air discharged from the discharge outlet 30 (36) undergoes relative movement (a simple tabletop 60 instead of a suction table and a roller conveyor 150 and one dust removal device 10 instead of a roller conveyor 150 and two dust removal devices). As a result, the above-described dust removal device 10 can be provided with more user friendliness.

Above, embodiments of the present invention were explained, but these embodiments and modifications of parts were presented only as examples and are not intended to limit the scope of the invention. The new embodiments described above can be carried out in other various modes and can be subjected to various omissions, substitutions, or changes within a range that does not depart from the gist of the invention. These embodiments and modifications are encompassed by the scope and gist of the invention and by the inventions set forth in the claims.

### INDUSTRIAL APPLICABILITY

The dust removal device according to the present invention has good user friendliness and is useful as a dust removal device which discharges air to the surface of an object to be dedusted which undergoes relative movement while drawing in air above the surface of the object to be dedusted to remove dust from the surface of the object to be dedusted.

### REFERENCE SIGNS LIST

10 dust removal device
11 dedusting head
11a head block
11b suction regulating plate
12 supply port
13 exhaust duct unit
13a flange
14 exhaust port
15 air ejection chamber
16a front side air suction chamber
16b rear side air suction chamber
17a front side suction regulating holes
17b rear side suction regulating holes
21a front side first suction inlet
21b front side second suction inlet
22a rear side first suction inlet
22b rear side second suction inlet
30 discharge outlet
30a slit
31 groove
32a connecting path
32b gas discharge path
33 opening
36 discharge outlet
36a longitudinal slit
36b slit
45 elongated holes
46a connecting path
46b gas discharge path
47 opening
60 tabletop
62 roller conveyor
100 sheet-shaped object
150 plate-shaped object

1. A dust removal device provided with a discharge outlet and suction inlet facing the surface of an object to be dedusted undergoing relative movement and arranged at a predetermined interval along the direction of relative movement of the object to be dedusted and that discharges gas from the discharge outlet to the surface of the object to be dedusted while drawing in the gas above the surface of the object to be dedusted through the suction inlet,
the dust removal device having a gas discharge path with a shape that gradually expands from an opening facing the object to be dedusted to the discharge outlet.

2. The dust removal device according to claim 1, wherein a cross-section of the gas discharge path taken perpendicular to the surface of the object to be dedusted has a shape which gradually expands in an arc shape.

3. A dust removal device provided with a discharge outlet and suction inlet facing the surface of an object to be dedusted undergoing relative movement and arranged at a predetermined interval along the direction of the relative movement of the object to be dedusted and that discharges gas from the discharge outlet to the surface of the object to be dedusted while drawing in a gas above the surface of the object to be dedusted through the suction inlet, wherein the discharge outlet includes a plurality of slits which are arranged in a direction traversing the direction of the relative movement of the object to be dedusted with each slit extending in a direction traversing the arrangement direction,
a gas discharge path is provided for each of the plurality of slits and extends from an opening facing the object to be dedusted to the slit, and
a cross-section of the gas discharge path taken perpendicular to the slit has a shape which gradually expands from the opening to the slit.

4. The dust removal device according to claim 3, wherein the cross-section has a shape which gradually expands in an arc shape.

5. The dust removal device according to claim 3, wherein each of the plurality of slits is formed inclining obliquely to the direction of relative movement of the object to be dedusted.

6. The dust removal device according to claim 3, wherein the plurality of slits are arranged in parallel.

7. The dust removal device according to claim 3, wherein the discharge outlet includes a main slit extending traversing the plurality of slits.

8. The dust removal device according to claim 7 wherein each of the plurality of slits extends in parallel to the direction of relative movement of the object to be dedusted.
